(19) United States
(12) Patent Application Publication
(10) Pub. No.: US 2010/0039057 A1
(43) Pub. Date: Feb. 18, 2010

(54) ANTI-PINCH METHOD AND DEVICE FOR CONTROLLING AN OPENABLE AND CLOSABLE BODY

(76) Inventor: Kune-Muh Tsai, Tainan City (TW)

Correspondence Address: FITZPATRICK CELLA HARPER & SCINTO, 1290 Avenue of the Americas, NEW YORK, NY, 10104-3800, US

(21) Appl. No.: 12/606,307

(22) Filed: Oct. 27, 2009

(30) Foreign Application Priority Data
Apr. 30, 2008 (TW) 097115886
May 7, 2008 (TW) 097116786

(51) Int. Cl. H02P 7/00

(52) U.S. Cl. 318/434

(57) ABSTRACT

In an anti-pinch method and device for controlling an openable and closable body, a driving circuit operatively drives a motor with a driving current to move the body relative to a frame body between closing and open positions. A current sensor generates a sensing signal corresponding to the driving current. A control unit calculates a difference between magnitude of the driving current and a reference current value upon detecting that the magnitude of the driving current is greater than the reference current value, and outputs an abnormal signal indicative of an object being pinched between the body and the frame body upon detecting that the difference is greater than a predetermined threshold value. The driving circuit is responsive to the abnormal signal from the control unit to perform one of stopping driving of the motor and driving the motor to move the body toward the open position.

### BACKGROUND OF THE INVENTION

1. Field of the Invention

The invention relates to an anti-pinch method and device for controlling an openable and closable body.

2. Description of the Related Art

Referring to FIG. 1, a conventional anti-pinch device 2 for controlling an openable and closable body, such as a car window 20, is shown to include a motor 21 operatively connected to the car window 20, a driving circuit 22 coupled to the motor 21 for operatively driving the motor 21 with a driving current to move the car window 20 relative to a frame body 20′ between an open position and a closing position, a current sensor 23 coupled to the driving circuit 22 for generating a sensing signal corresponding to the driving current, a controller 24 coupled to the driving circuit 22 and the current sensor 23, and a memory 25 coupled to the controller 24. The controller 24 receives the sensing signal from the current sensor 23, and determines whether magnitude of the driving current is greater than a predetermined threshold value stored in the memory 25 based on the sensing signal from current sensor 23. When the magnitude of the driving current is greater than the predetermined threshold value, the motor 21 is judged to operate under an abnormal condition where an object, such as a user's arm, is pinched between the car window 20 and the frame body 20′. When the motor 21 operates under the abnormal condition, the controller 24 controls the driving circuit 22 to perform one of stopping driving of the motor 21 and driving the motor 21 to move the car window 20 toward the open position.

However, for the aforementioned conventional anti-pinch device 2, when the motor 21 wears out after a long period of use, there is an error in judgment on the abnormal condition based on the predetermined threshold value stored in the memory 25.

In order to alleviate the error in judgment on the abnormal condition, U.S. Pat. No. 7,170,244 discloses a conventional anti-pinch activator that judges an abnormal condition based on a dynamically adjustable threshold value, and U.S. Pat. No. 7,309,971 discloses a conventional control device that judges an abnormal condition by comparing an accumulation value with a reference value. However, the conventional anti-pinch activator and the conventional control device need a memory or a number of registers for a complicated judgment procedure, thereby resulting in relatively high costs.

### SUMMARY OF THE INVENTION

Therefore, an object of the present invention is to provide an anti-pinch method and device for controlling an openable and closable body that can overcome the aforesaid drawbacks of the prior art.

According to one aspect of the present invention, there is provided an anti-pinch device for controlling an openable and closable body. The anti-pinch device comprises:

a motor adapted to be operatively connected to the openable and closable body;

a driving circuit coupled to the motor for operatively driving the motor with a driving current to move the openable and closable body relative to a frame body between a closing position and an open position;

a current sensor coupled to the driving circuit for generating a sensing signal corresponding to the driving current; and

a control unit coupled to the current sensor and the driving circuit, determining whether magnitude of the driving current is greater than a reference current value based on the sensing signal from the current sensor, calculating a difference between the magnitude of the driving current and the reference current value upon detecting that the magnitude of the driving current is greater than the reference current value, and outputting an abnormal signal, indicative of an object being pinched between the openable and closable body and the frame body, to the driving circuit upon detecting that the difference is greater than a predetermined threshold value.

The driving circuit is responsive to the abnormal signal from the control unit to perform one of stopping driving of the motor and driving the motor to move the openable and closable body toward the open position.

According to another aspect of the present invention, there is provided an anti-pinch method of controlling an openable and closable body. The openable and closable body is driven by a motor to move relative to a frame body between a closing position and an open position. The anti-pinch method comprises the steps of:

a) driving the motor with a driving current to move the openable and closable body from the open position to the closing position;

b) sensing the driving current for the motor to generate a sensing signal;

c) determining whether magnitude of the driving current is greater than a reference current value based on the sensing signal generated in step b);

d) calculating a difference between the magnitude of the driving current and the reference current value when it is determined in step c) that the magnitude of the driving current is greater than the reference current value;

e) determining whether the difference is greater than a predetermined threshold value; and

f) performing one of stopping driving of the motor and driving the motor to move the openable and closable body toward the open position when it is determined in step e) that the difference is greater than the predetermined threshold value.

According to a further aspect of the present invention, there is provided an anti-pinch device for controlling an openable and closable body. The anti-pinch device comprises:

a motor adapted to be operatively connected to the openable and closable body;

a driving circuit coupled to the motor for operatively driving the motor to move the openable and closable body relative to a frame body between a closing position and an open position;

a sensor for generating a sensing signal indicative of a rotation speed of the motor;

a speed calculator coupled to the sensor for receiving the sensing signal therefrom and for generating an output signal corresponding to the rotation speed of the motor based on the sensing signal from the sensor; and

a control unit coupled to the speed calculator for receiving the output signal therefrom, determining whether magnitude of the rotation speed of the motor is less than a reference speed value based on the output signal from the speed calculator, calculating a difference between the magnitude of the rotation speed of the motor and the reference speed value upon detecting that the magnitude of the rotation speed of the motor is less than the reference speed value, and outputting an abnormal signal, indicative of an object being pinched between the openable and closable body and the frame body, to the driving circuit upon detecting that the difference is greater than a predetermined threshold value.

The driving circuit is responsive to the abnormal signal from the control unit to perform one of stopping driving of the motor and driving the motor to move the openable and closable body toward the open position.

According to still another aspect of the present invention, there is provided an anti-pinch method of controlling an openable and closable body. The openable and closable body is driven by a motor to move relative to a frame body between a closing position and an open position. The anti-pinch method comprises the steps of:

a) driving the motor to move the openable and closable body from the open position to the closing position;

b) sensing a rotation speed of the motor to generate a sensing signal and to obtain an output signal corresponding to the rotation speed of the motor based on the sensing signal;

c) determining whether magnitude of the rotation speed of the motor is less than a reference speed value based on the output signal obtained in step b);

d) calculating a difference between the magnitude of the rotation speed of the motor and the reference speed value when it is determined in step c) that the magnitude of the rotation speed of the motor is less than the reference speed value;

e) determining whether the difference is greater than a predetermined threshold value; and

f) performing one of stopping driving of the motor and driving the motor to move the openable and closable body toward the open position when it is determined in step e) that the difference is greater than the predetermined threshold value.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a conventional anti-pinch device for controlling an openable and closable body;

FIG. 2 is a schematic circuit block diagram illustrating the first preferred embodiment of an anti-pinch device for controlling an openable and closable body according to the present invention;

FIG. 3 is a plot illustrating how the rotation speed of a motor is adjusted based on a driving current from a driving circuit of the first preferred embodiment;

FIGS. 4 to 9 illustrate different first sensing signals generated by a current sensor of the first preferred embodiment;

FIG. 10 is a flowchart illustrating how the first preferred embodiment performs an anti-pinch method of controlling an openable and closable body;

FIG. 11 is a schematic circuit block diagram illustrating the second preferred embodiment of an anti-pinch device for controlling an openable and closable body according to the present invention; and

FIG. 12 is a flowchart illustrating how the second preferred embodiment performs an anti-pinch method of controlling an openable and closable body.

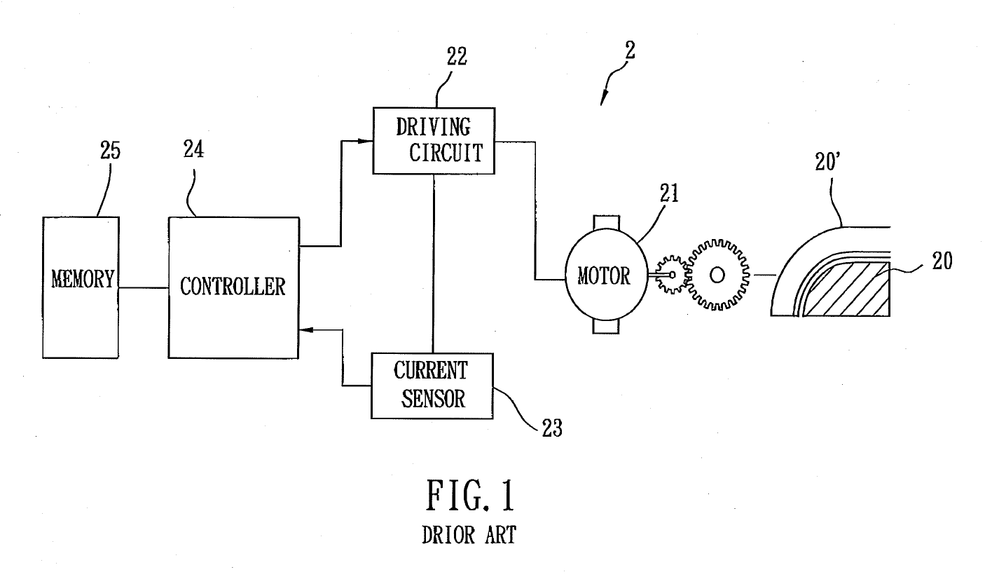

### DETAILED DESCRIPTION OF THE PREFERRED EMBODIMENTS

Before the present invention is described in greater detail, it should be noted that like elements are denoted by the same reference numerals throughout the disclosure.

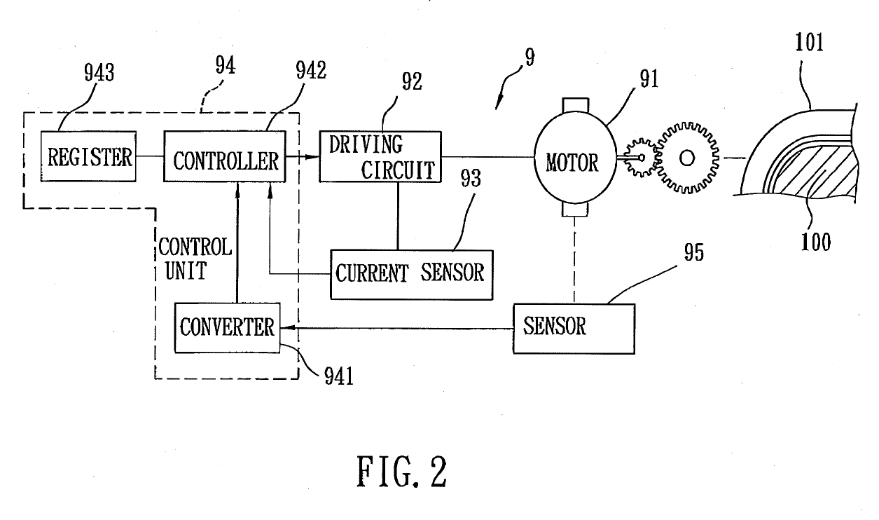

Referring to FIG. 2, the first preferred embodiment of an anti-pinch device 9 for controlling an openable and closable body, such as a car window 100, according to the present invention is shown to include a motor 91, a driving circuit 92, a current sensor 93, a sensor 95, and a control unit 94.

The motor 91 is adapted to be operatively connected to the car window 100.

The driving circuit 92 is coupled to the motor 91 for operatively driving the motor 91 with a driving current to move the car window 100 relative to a frame body 101 between a closing position and an open position.

The current sensor 93 is coupled to the driving circuit 92 for generating a first sensing signal corresponding to the driving current.

The sensor 95, such as a Hall sensor or an encoder, generates a second sensing signal indicative of a rotation speed of the motor 91.

In this embodiment, the control unit 94 includes a converter 941 coupled to the sensor 95 for receiving the second sensing signal therefrom, a controller 942 coupled to the converter 941, the current sensor 93 and the driving circuit 92, and receiving the first sensing signal from the current sensor 93, and a register 943 coupled to the controller 942. The converter 941 provides an output indicative of a current position of the car window 100 to the controller 942 based on the second sensing signal. The controller 942 determines whether the current position of the car window 100 is within an anti-pinch region defined between the closing position, and a predetermined position between the open position and the closing position based on the output from the converter 941. The controller 942 samples the first sensing signal from the current sensor 93 to obtain magnitude of the driving current upon detecting that the current position is within the anti-pinch region, determines whether the magnitude of the driving current is greater than a reference current value stored in the register 943, calculates a difference between the magnitude of the driving current and the reference current value upon detecting that the magnitude of the driving current is greater than the reference current value, and outputs to the driving circuit 92 an abnormal signal indicative of an abnormal condition wherein an object, such as a user's arm, is pinched between the car window 100 and the frame body 101 upon detecting that the difference is greater than a predetermined threshold value. Eventually, the reference current value stored in the register 943 will be updated when the current sensor 93 starts to generate the next sensing signal corresponding to the driving current. That is, the driving current will be stored in the register 943 once the current sensor 93 is restarted.

The driving circuit 92 is responsive to the abnormal signal from the controller 942 to perform one of stopping driving of the motor 91 and driving the motor 91 to move the car window 100 toward the open position.

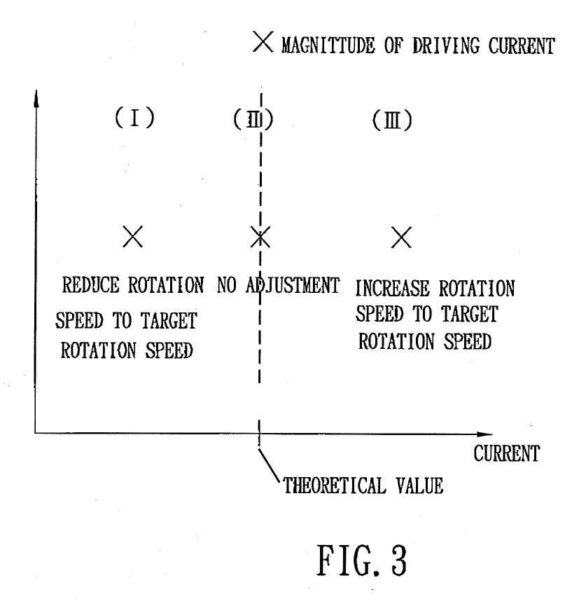

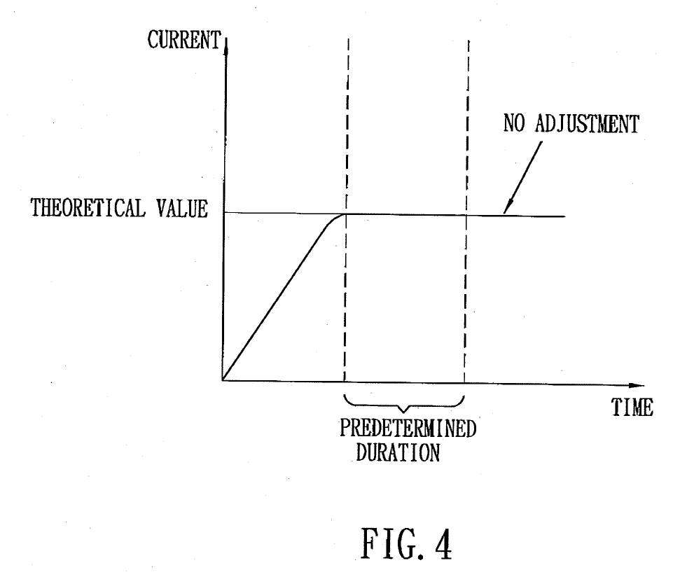

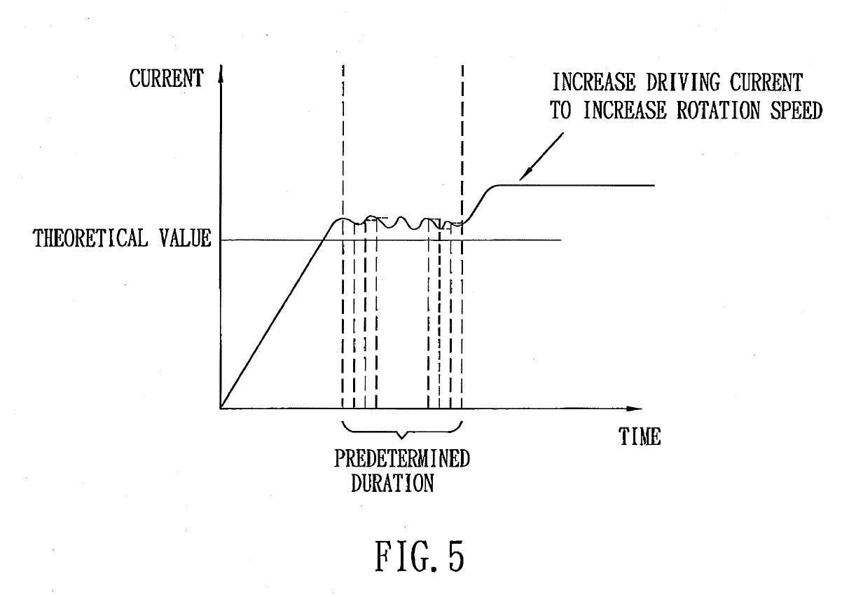

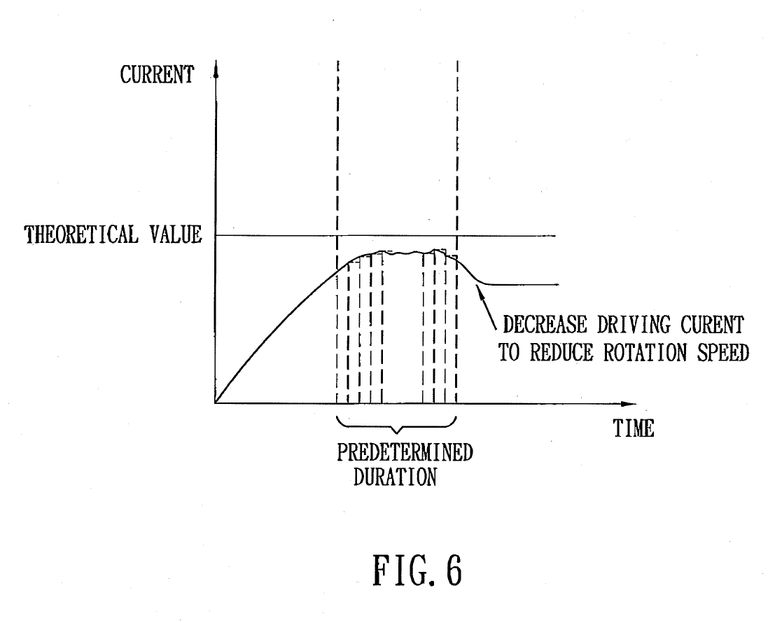

On the other hand, the controller 942 outputs an adjusting signal to the driving current 92 upon detecting that the magnitude of the driving current is not equal to a theoretical value corresponding to a theoretical load of the motor 91 for a predetermined duration. The driving circuit 92 is responsive to the adjusting signal from the controller 942 to adjust the driving current provided to the motor 91 so that the motor 91 operates at a target rotation speed. For example, the first sensing signal shown in FIG. 4 indicates that the magnitude of the driving current is equal to the theoretical value during the predetermined duration, the first sensing signal shown in FIG. 5 indicates that the magnitude of the driving current is greater than the theoretical value during the predetermined duration such that the driving current should be increased to increase the rotation speed of the motor 91, and the first sensing signal shown in FIG. 6 indicates that the magnitude of the driving current is less than the theoretical value during the predetermined duration such that the driving current should be decreased to reduce the rotation speed of the motor 91. As a result, referring to FIG. 3, when the magnitude of the driving current represented by a symbol “x” is equal to the theoretical value, as indicated by a dotted line (II) in FIG. 3, adjustment of the rotation speed of the motor 91 is not required. When the magnitude of the driving current is less than the theoretical value, as indicated by a region (I) of FIG. 3, the rotation speed of the motor 91 should be reduced to the target rotation speed. When the magnitude of the driving current is greater than the theoretical value, as indicated by a region (III) of FIG. 3, the rotation speed of the motor 91 should be increased to the target rotation speed.

Alternatively, the controller 942 outputs the adjusting signal to the driving circuit 92 upon detecting that the difference between the magnitude of the driving current and the reference current value is larger than a theoretical difference value that is smaller than the predetermined threshold value for the predetermined duration. In this embodiment, the theoretical value serves as the reference current value.

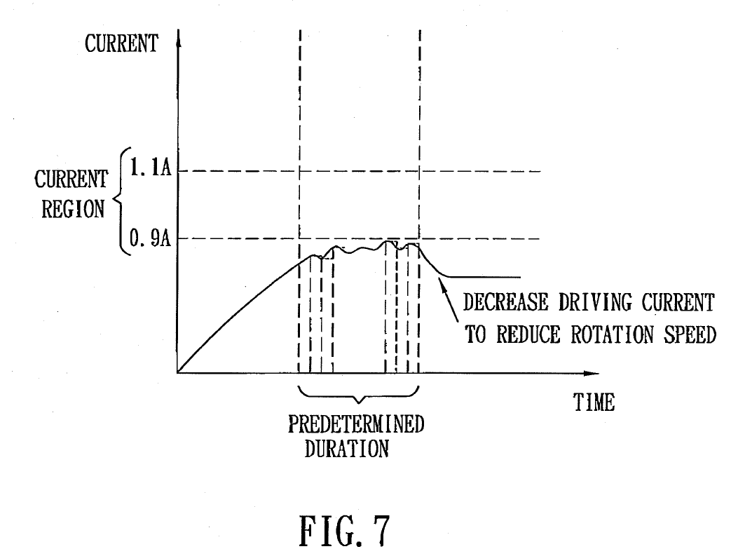

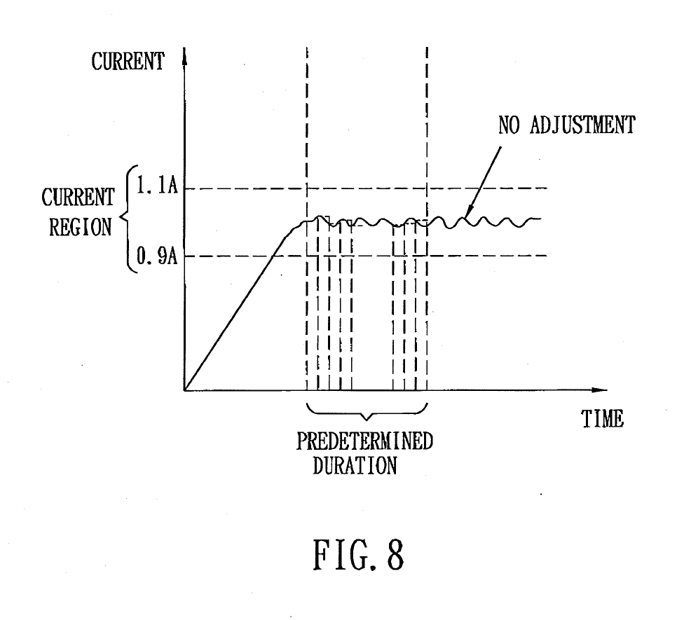

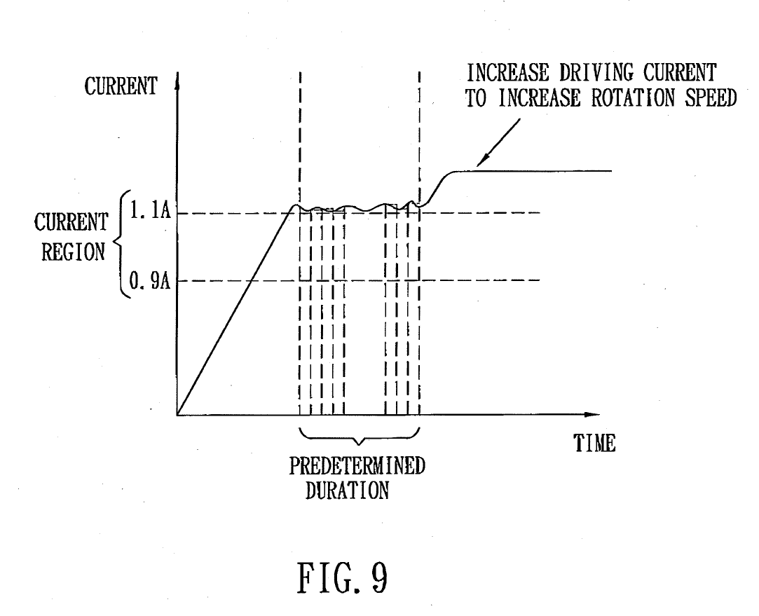

In an example, the theoretical value is equal to 1 A, and the theoretical difference value is equal to 0.1 A such that a tolerable region from 0.9 A to 1.1 A is set for the driving current. Therefore, referring to FIG. 7, the first sensing signal indicates that the magnitude of the driving current is less than 0.9 A during the predetermined duration such that the driving current should be decreased to reduce the rotation speed of the motor 91 to the target rotation speed. Referring to FIG. 8, the first sensing signal indicates that the magnitude of the driving current is within the tolerable region during the predetermined duration such that adjustment of the driving current is not required. Referring to FIG. 9, the first sensing signal indicates that the magnitude of the driving current is greater than 1.1 A during the predetermined duration such that the driving current should be increased to increase the rotation speed of the motor 91 to the target rotation speed.

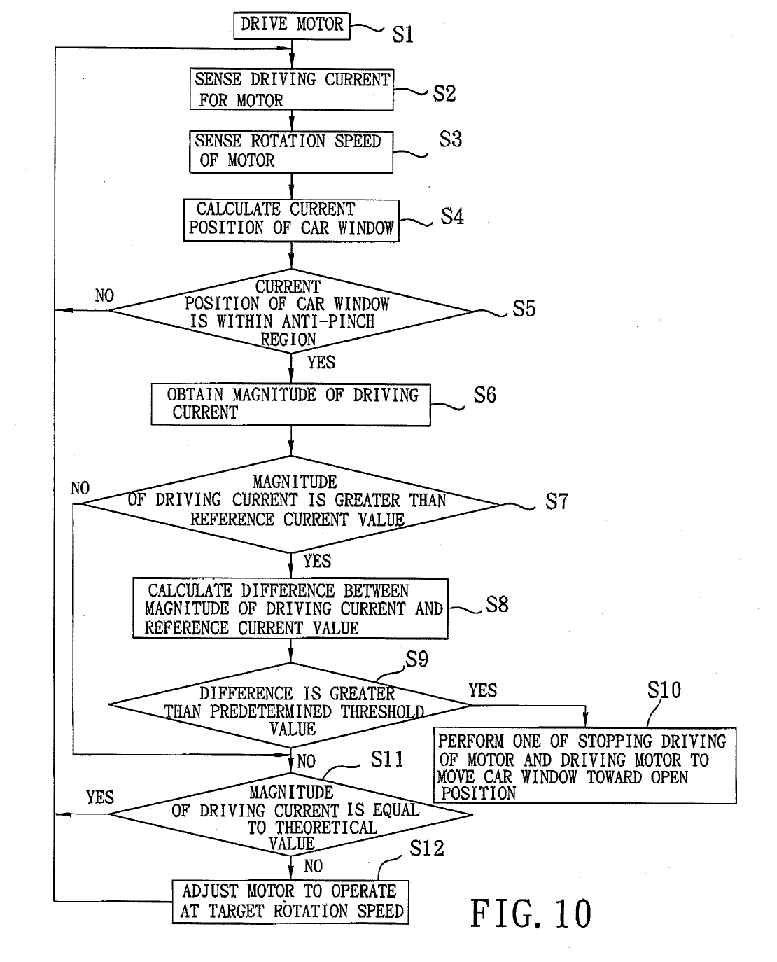

FIG. 10 is a flowchart illustrating how the anti-pinch device 9 of the first preferred embodiment performs an anti-pinch method of controlling the car window 100.

In step S1, the driving circuit 92 drives the motor 91 to move the car window 100 from the open position to the closing position. In step S2, the current sensor 92 senses the driving current for the motor 91 to generate the first sensing signal. In step S3, the sensor 95 senses the rotation speed of the motor 91 to generate the second sensing signal. In step S4, the converter 941 of the control unit 94 calculates the current position of the car window 100 based on the second sensing signal from the sensor 95. In step S5, the controller 942 of the control unit 94 determines whether the current position of the car window 100 is within the anti-pinch region. If affirmative, the flow proceeds to step S6. Otherwise, the flow goes back to step S2. In step S6, the controller 942 samples the first sensing signal from the current sensor 93 to obtain the magnitude of the driving current. In step S7, the controller 942 determines whether the magnitude of the driving current is greater than the reference current value. If affirmative, the flow proceeds to step S8. Otherwise, the flow goes to step S11. In step S8, the controller 942 calculates the difference between the magnitude of the driving current and the reference current value. In step S9, the controller 942 determines whether the difference is greater than the predetermined threshold value. If negative, the flow goes to step S11. When it is determined in step S9 that the difference is greater than the predetermined threshold value, the controller 942 outputs the abnormal signal to the driving circuit 92, and the flow then proceeds to step S10. In step S10, the driving circuit 92 responds to the abnormal Signal from the controller 942 to perform one of stopping driving of the motor 91 and driving the motor 91 to move the car window 100 toward the open position. In step S11, the controller 942 determines whether the magnitude of the driving current is equal to the theoretical value. If affirmative, the flow goes back to step S2. When it is determined in step S11 that the magnitude of the driving current is not equal to the theoretical value, the controller 942 outputs the adjusting signal to the driving circuit, and the flow goes to step S12. In step S12, the driving circuit 92 responds to the adjusting signal from the controller 942 to adjust the driving current provided to the motor 91 so that the motor 91 operates at the target rotation speed, and the flow goes back to step S2.

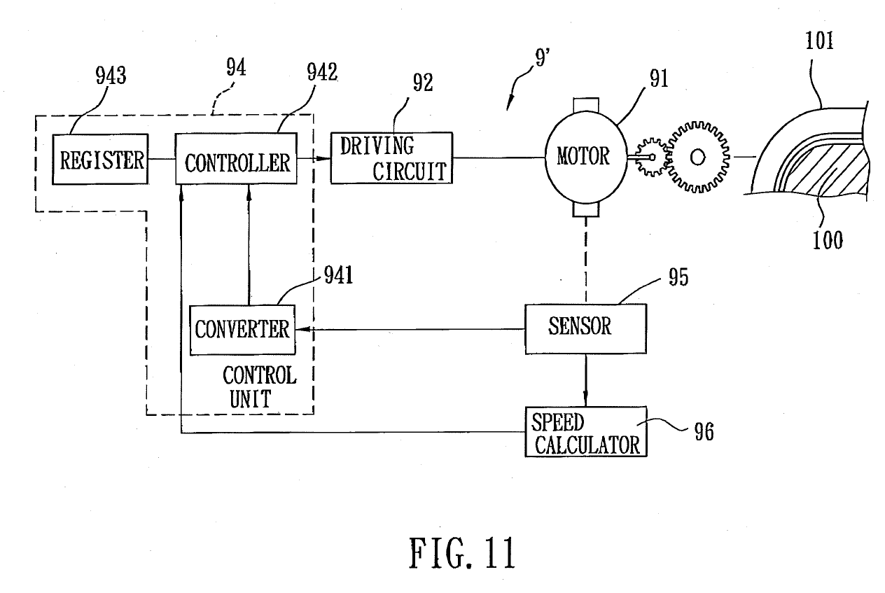

FIG. 11 illustrates the second preferred embodiment of an anti-pinch device 9′ for controlling an openable and closable body, such as the car window 100, according to this invention, which is a modification of the first preferred embodiment. In this embodiment, a speed calculator 96 replaces the current sensor 93 of the first preferred embodiment, and is coupled to the sensor 95 and the controller 942 of the control unit 94 for receiving the second sensing signal from the sensor 95 and for generating an output signal corresponding to the rotation speed of the motor 91 based on the second sensing signal from the sensor 95.

The controller 942 samples the output signal from the speed calculator 96 to obtain magnitude of the rotation speed of the motor 91 upon detecting that the current position of the car window 100 is within the anti-pinch region based on the second sensing signal from the sensor 95, determines whether the magnitude of the rotation speed of the motor 91 is less than a reference speed value stored in the register 943, calculates a difference between the magnitude of the rotation speed of the motor 91 and the reference speed value upon detecting that the magnitude of the rotation speed of the motor 91 is less than the reference speed value, and outputs the abnormal signal to the driving circuit 92 upon detecting that the difference is greater than a predetermined threshold value. Eventually, the reference speed value stored in the register 943 will be updated when the speed calculator 96 starts to generate a next output signal corresponding to the rotation speed of the motor 91 based on the second sensing signal from the sensor 95. That is, the rotation speed will be stored in the register 943 once the speed calculator 96 is restarted.

Furthermore, the controller 942 controls the driving circuit 92 to adjust the motor 91 to operate at the target rotation speed upon detecting that the magnitude of the rotation speed of the motor is not equal to that of the target rotation speed for the predetermined duration.

More specifically, when the magnitude of the rotation speed of the motor 91 is equal to that of the target rotation speed, adjustment of the rotation speed of the motor 91 is not required. When the magnitude of the rotation speed of the motor 91 is less than that of the target rotation speed, the rotation speed of the motor 91 should be increased to the target rotation speed. When the magnitude of the rotation speed of the motor 91 is greater than that of the target rotation speed, the rotation speed of the motor 91 should be reduced to the target rotation speed.

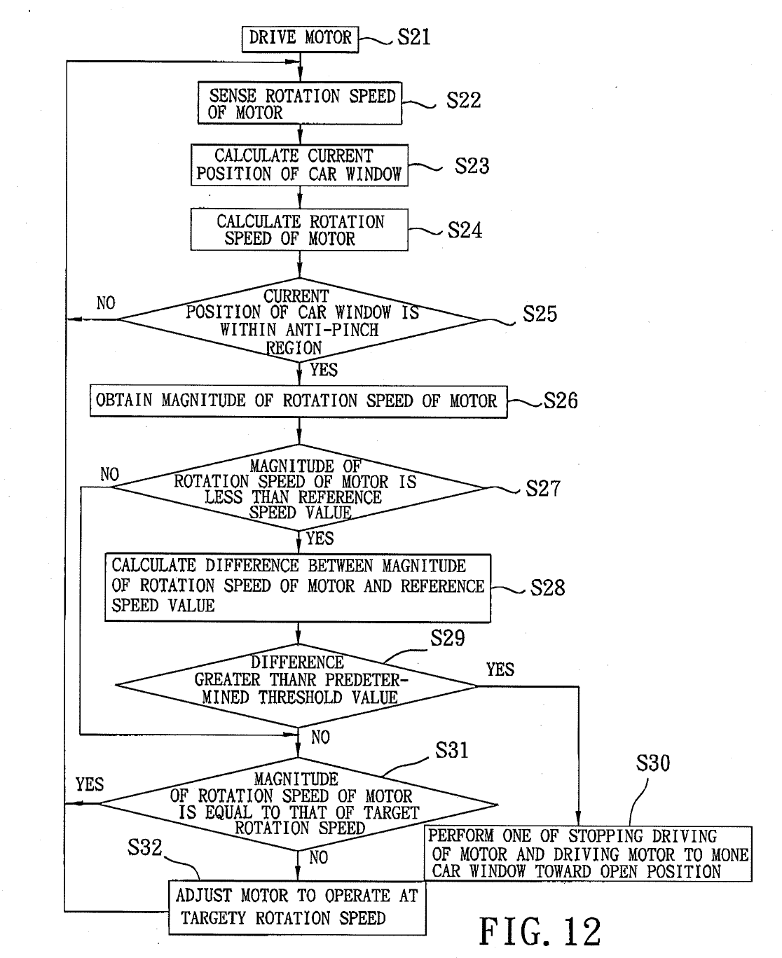

FIG. 12 is a flowchart illustrating how the anti-pinch device 9′ of the second preferred embodiment performs an anti-pinch method of controlling the car window 100.

In step S21, the driving circuit 92 drives the motor 91 to move the car window 100 from the open position to the closing position. In step S22, the sensor 95 senses the rotation speed of the motor 91 to generate the second sensing signal. In step S23, the converter 941 of the control unit 94 calculates the current position of the car window 100 based on the second sensing signal from the sensor 95. In step S24, the speed calculator 96 generates the output signal corresponding to the rotation speed of the motor 91 based on the second sensing signal from the sensor 95, and provides the output signal to the controller 942 of the control unit 94. In step S25, the controller 942 determines whether the current position of the car window 100 is within the anti-pinch region. If affirmative, the flow proceeds to step S26. Otherwise, the flow goes back to step S22. In step S26, the controller 942 samples the output signal from the speed calculator 96 to obtain the magnitude of the rotation speed of the motor 91. In step S27, the controller 942 determines whether the magnitude of the rotation speed of the motor 91 is less than the reference speed value. If affirmative, the flow proceeds to step S28. Otherwise, the flow goes to step S31. In step S28, the controller 942 calculates the difference between the magnitude of the rotation speed of the motor 91 and the reference speed value. In step S29, the controller 942 determines whether the difference is greater than the predetermined threshold value. If negative, the flow goes to step S31. When it is determined in step S29 that the difference is greater than the predetermined threshold value, the controller 942 outputs the abnormal signal to the driving circuit 92, and the flow then proceeds to step S30. In step S30, the driving circuit 92 responds to the abnormal signal from the controller 942 to perform one of stopping driving of the motor 91 and driving the motor 91 to move the car window 100 toward the open position. In step S31, the controller 942 determines whether the magnitude of the rotation speed of the motor 91 is equal to that of the target rotation speed. If affirmative, the flow goes back to step S22. Otherwise, the flow goes to step S32. In step S32, the controller 942 controls the driving circuit 92 to adjust the motor 91 to operate at the target rotation speed, and the flow goes back to step S22.

In sum, the anti-pinch devices 9, 9′ of the present invention utilize the driving current for the motor 91 sensed by the current sensor 93 and the rotation speed of the motor 91 obtained by the speed calculator 96 to determine whether the abnormal condition occurs, respectively. In this way, since the factors related to wear of the motor 91 as mentioned hereinabove have been considered, an error in judgment on the abnormal condition can be minimized. Therefore, the anti-pinch device 9, 9′ of the present invention has improved reliability. On the other hand, only one register 943 is used in the anti-pinch device 9, 9′ of the present invention for storing the reference current value or the reference speed value, and is less expensive as compared to the memory or the registers used in the aforementioned prior art, thereby resulting in a relatively low cost.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An anti-pinch device for controlling an openable and closable body, comprising:
a motor adapted to be operatively connected to the openable and closable body;
a driving circuit coupled to said motor for operatively driving said motor with a driving current to move the openable and closable body relative to a frame body between a closing position and an open position;
a current sensor coupled to said driving circuit for generating a first sensing signal corresponding to the driving current; and
a control unit coupled to said current sensor and said driving circuit, determining whether magnitude of the driving current is greater than a reference current value based on the first sensing signal from said current sensor, calculating a difference between the magnitude of the driving current and the reference current value upon detecting that the magnitude of the driving current is greater than the reference current value, and outputting an abnormal signal, indicative of an object being pinched between the openable and closable body and the frame body, to said driving circuit upon detecting that the difference is greater than a predetermined threshold value;
wherein said driving circuit is responsive to the abnormal signal from said control unit to perform one of stopping driving of said motor and driving said motor to move the openable and closable body toward the open position.

2. The anti-pinch device as claimed in claim 1, wherein:
said control unit outputs an adjusting signal to said driving circuit upon detecting that the magnitude of the driving current is not equal to a theoretical value corresponding to a theoretical load of said motor; and
said driving circuit is responsive to the adjusting signal from said control unit to adjust the driving current provided to said motor so that said motor operates at a target rotation speed.

3. The anti-pinch device as claimed in claim 2, wherein said control unit outputs the adjusting signal to said driving circuit after a predetermined duration during which the magnitude of the driving current is not equal to the theoretical value.

4. The anti-pinch device as claimed in claim 1, wherein:
said control unit outputs an adjusting signal to said driving circuit upon detecting that the difference between the magnitude of the driving current and the reference current value is larger than a theoretical difference value that is smaller than the predetermined threshold value for a predetermined duration; and
said driving circuit is responsive to the adjusting signal from said control unit to adjust the driving current provided to said motor so that said motor operates at a target rotation speed.

5. The anti-pinch device as claimed in claim 1, wherein said control unit includes a register for storing the reference current value.

6. The anti-pinch device as claimed in claim 1, further comprising a sensor for generating a second sensing signal indicative of a rotation speed of said motor;
wherein said control unit includes a converter coupled to said sensor for receiving the second sensing signal therefrom and for obtaining a current position of the openable and closable body based on the second sensing signal from said sensor; and
wherein said control unit samples the first sensing signal from said current sensor to obtain the magnitude of the driving current upon detecting that the current position of the openable and closable body is within an anti-pinch region defined between the closing position, and a predetermined position between the open position and the closing position.

7. An anti-pinch method of controlling an openable and closable body, the openable and closable body being driven by a motor to move relative to a frame body between a closing position and an open position, the anti-pinch method comprising the steps of:
a) driving the motor with a driving current to move the openable and closable body from the open position to the closing position;
b) sensing the driving current for the motor to generate a first sensing signal;
c) determining whether magnitude of the driving current is greater than a reference current value based on the first sensing signal generated in step b);
d) calculating a difference between the magnitude of the driving current and the reference current value when it is determined in step c) that the magnitude of the driving current is greater than the reference current value;
e) determining whether the difference is greater than a predetermined threshold value; and
f) performing one of stopping driving of the motor and driving the motor to move the openable and closable body toward the open position when it is determined in step e) that the difference is greater than the predetermined threshold value.

8. The anti-pinch method as claimed in claim 7, further comprising the steps:
g) determining whether the magnitude of the driving current is equal to a theoretical value corresponding to a theoretical load of the motor based on the first sensing signal generated in step b); and
h) adjusting the driving current for the motor so that the motor operates at a target rotation speed when it is determined in step g) that the magnitude of the driving current is not equal to the theoretical value.

9. The anti-pinch method as claimed in claim 8, wherein, in step h), the driving current is adjusted after a predetermined duration during which the magnitude of the driving current is not equal to the theoretical value.

10. The anti-pinch method as claimed in claim 7, further comprising, prior to step c), the steps of:
b-1) sensing a rotation speed of the motor to generate a second sensing signal;
b-2) calculating a current position of the openable and closable body based on the second sensing signal generated in step b-1); and
b-3) determining whether the current position of the openable and closable body is within an anti-pinch region defined between the closing position, and a predetermined position between the open position and the closing position;
wherein, when it is determined in step b-3) that the current position of the openable and closable body is within the anti-pinch region, step c) is performed.

11. An anti-pinch device for controlling an openable and closable body, comprising:
a motor adapted to be operatively connected to the openable and closable body;
a driving circuit coupled to said motor for operatively driving said motor to move the openable and closable body relative to a frame body between a closing position and an open position;
a sensor for generating a sensing signal indicative of a rotation speed of said motor;
a speed calculator coupled to said sensor for receiving the sensing signal therefrom and for generating an output signal corresponding to the rotation speed of said motor based on the sensing signal from said sensor; and
to a control unit coupled to said speed calculator for receiving the output signal therefrom, determining whether magnitude of the rotation speed of said motor is less than a reference speed value based on the output signal from said speed calculator, calculating a difference between the magnitude of the rotation speed of said motor and the reference speed value upon detecting that the magnitude of the rotation speed of said motor is less than the reference speed value, and outputting an abnormal signal, indicative of an object being pinched between the openable and closable body and the frame body, to said driving circuit upon detecting that the difference is greater than a predetermined threshold value;
wherein said driving circuit is responsive to the abnormal signal from said control unit to perform one of stopping driving of said motor and driving said motor to move the openable and closable body toward the open position.

12. The anti-pinch device as claimed in claim 11, wherein said control unit controls said driving circuit to adjust said motor to operate at a target rotation speed upon detecting that the magnitude of the rotation speed of said motor is not equal to that of the target rotation speed.

13. The anti-pinch device as claimed in claim 12, wherein said control unit enables said driving circuit to adjust said motor to operate at the target rotation speed after a predetermined duration during which the magnitude of the rotation speed of said motor is not equal to that of the target rotation speed.

14. The anti-pinch device as claimed in claim 11, wherein said control unit includes a register for storing the reference speed value.

15. The anti-pinch device as claimed in claim 11, wherein:
said control unit includes a converter coupled to said sensor for receiving the sensing signal therefrom, and for obtaining a current position of the openable and closable body based on the sensing signal; and
said control unit samples the output signal from said speed calculator to obtain the magnitude of the rotation speed of said motor upon detecting that the current position of the openable and closable body is within an anti-pinch region defined between the closing position, and a predetermined position between the open position and the closing position.

16. An anti-pinch method of controlling an openable and closable body, the openable and closable body being driven by a motor to move relative to a frame body between a closing position and an open position, the anti-pinch method comprising the steps of:
a) driving the motor to move the openable and closable body from the open position to the closing position;
b) sensing a rotation speed of the motor to generate a sensing signal and to obtain an output signal corresponding to the rotation speed of the motor based on the sensing signal;
c) determining whether magnitude of the rotation speed of the motor is less than a reference speed value based on the output signal obtained in step b);
d) calculating a difference between the magnitude of the rotation speed of the motor and the reference speed value when it is determined in step c) that the magnitude of the rotation speed of the motor is less than the reference speed value;
e) determining whether the difference is greater than a predetermined threshold value; and
f) performing one of stopping driving of the motor and driving the motor to move the openable and closable body toward the open position when it is determined in step e) that the difference is greater than the predetermined threshold value.

17. The anti-pinch method as claimed in claim 16, further comprising the steps of:
g) determining whether the magnitude of the rotation speed of the motor is equal to that of a target rotation speed based on the output signal obtained in step b); and
h) adjusting the motor to operate at the target rotation speed when it is determined in step g) that the magnitude of the rotation speed of the motor is not equal to that of the target rotation speed.

18. The anti-pinch method as claimed in claim 17, wherein, in step h), the motor is adjusted after a predetermined duration during which the magnitude of the rotation speed of the motor is not equal to that of the target rotation speed.

19. The anti-pinch method as claimed in claim 16, further comprising, prior to step c), the steps of:
b-1) calculating a current position of the openable and closable body based on the sensing signal generated in step b); and
b-2) determining whether the current position of the openable and closable body is within an anti-pinch region defined between the closing position, and a predetermined position between the open position and the closing position;
wherein, when it is determined in step b-2) that the current position of the openable and closable body is within the anti-pinch region, step c) is performed.
